(19) United States
(12) Patent Application Publication
(10) Pub. No.: US 2020/0242652 A1
(43) Pub. Date: Jul. 30, 2020

(54) SYSTEM AND METHOD FOR TRACKING PRODUCT AND SERVICE DISCOUNTS

(71) Applicant: Christopher Pruden, Woodstock, IL (US)

(72) Inventor: Christopher Pruden, Woodstock, IL (US)

(21) Appl. No.: 16/716,075

(22) Filed: Dec. 16, 2019

Related U.S. Application Data
(63) Continuation-in-part of application No. 16/532,055, filed on Aug. 5, 2019, now abandoned.
(60) Provisional application No. 62/714,242, filed on Aug. 3, 2018.

(51) Int. Cl. G06Q 30/02; H04W 4/23; H04W 4/021

(52) U.S. Cl. CPC G06Q 30/0224; H04W 4/021; H04W 4/23; G06Q 30/0205

(57) ABSTRACT

The present invention relates to a system and method for tracking product and service discounts. Specifically, the present invention comprises a consumer application resident on a smart phone for tracking discounts of products and services at retailers and a store application for informing consumers of discounts on products and services.

The present invention is a continuation-in-patent (CIP) of U.S. patent application Ser. No. 16/532,055, titled “System and Method for Tracking Product and Service Discounts,” filed Aug. 5, 2019, which claims priority to U.S. Provisional Pat. App. No. 62/714,242, titled “System and Method for Tracking Product and Service Discounts,” filed Aug. 3, 2019, each of which is incorporated herein by reference in its entirety.

### TECHNICAL FIELD

The present invention relates to a system and method for tracking product and service discounts. Specifically, the present invention comprises a consumer application resident on a smart phone for tracking discounts of products and services at retailers and a store application for informing consumers of discounts on products and services.

### BACKGROUND

Consumers, of course, wish to obtain the best deals on goods and services, but oftentimes it is difficult to track sales. Specifically, within a specific location area, there may be dozens if not hundreds of retail stores that provide competing items. Because of competition to attract customers, stores often run sales, discounts, coupons, or other like promotions to attract customers to stores. Of course, a sale, discount, coupon or promotion is no good to a customer if the customer is unaware of the sale.

A need exists for a system and method for alerting customers to promotions of retail goods and/or services. Specifically a need exists for a system and method that allows consumers to be alerted to specific discounts on identified products at specific locations that are most useful to a consumer.

A need further exists for a system and method to allow retail stores the ability to communicate with customers and/or potential customers more easily and effectively. More specifically, a need exists for a system and method to allow retail stores to provide information to a centralized system regarding promotions of particular retail goods and services whereby the information is communicated to customers and/or potential customers wishing for promotion information on the particular goods and services.

### SUMMARY OF THE INVENTION

The present invention relates to a system and method for tracking product and service discounts. Specifically, the present invention comprises a consumer application resident on a smart phone for tracking discounts of products and services at retailers and a store application for informing consumers of discounts on products and services.

To this end, in an embodiment of the present invention, a system for tracking product and service discounts is provided. The system comprises: a customer application resident on a smart phone, wherein the customer application provides alerts to a customer regarding promotions on pre-selected goods or services at a retail store location; and a retail store application on a computing device configured to allow a retail store to provide information concerning a sales promotion on one or more goods or services to the customer application resident on the smart phone.

In an embodiment, the customer application is configured to receive geolocation information from the customer.

In an embodiment, the geolocation information is entered by the customer.

In an embodiment, the geolocation information is a zip code.

In an embodiment, the geolocation information is tracked by the user's smart phone.

In an embodiment, the customer application is configured to provide an alert to the customer via the customer's smart phone when a retail store provides the sales promotion on a first good or service.

In an embodiment, the alert is configured to be provided to the customer when the retail store is also located within a pre-defined geographic location.

In an embodiment, the alert is configured to be provided to the customer when the customer tags the product within the customer application as being of interest to the customer.

In an embodiment, the retail store application is configured to provide information concerning a first good or service tagged by an interested customer.

In an embodiment, the retail store application is further configured to provide the information concerning the first good or service within a pre-defined geographic location.

In an alternate embodiment of the present invention, a method for tracking product and service discounts is provided. The method comprises the steps of: providing a customer application resident on a smart phone; providing a retail store application on a computing device; inputting information into the retail store application concerning a sales promotion on one or more goods or services; and providing an alert regarding the sales promotion on the smart phone of the one or more goods or services.

In an embodiment, the customer application is configured to receive geolocation information from the customer.

In an embodiment, the geolocation information is entered by the customer.

In an embodiment, the geolocation information is a zip code.

In an embodiment, the geolocation information is tracked by the user's smart phone.

In an embodiment, the method further comprises the step of: providing an alert to the customer via the customer's smart phone when a retail store provides the sales promotion on a first good or service.

In an embodiment, the method further comprises the step of: providing the alert to the customer when the retail store is also located within a pre-defined geographic location.

In an embodiment, the method further comprises the step of: providing the alert to the customer when the customer tags the product within the customer application as being of interest to the customer.

In an embodiment, the method further comprises the step of: providing information to a retail store concerning a first good or service tagged by an interested customer.

In an embodiment, the method further comprises the step of: providing the information to the retail store concerning the first good or service within a pre-defined geographic location.

It is, therefore, an advantage and objective of the present invention to provide a system and method for alerting customers to promotions of retail goods and/or services.

Specifically, it is an advantage and objective of the present invention to provide a system and method that allows consumers to be alerted to specific discounts on identified products at specific locations that are most useful to a consumer.

Further, it is an advantage and objective of the present invention to provide a system and method to allow retail stores the ability to communicate with customers and/or potential customers more easily and effectively.

More specifically, it is an advantage and objective of the present invention to provide a system and method to allow retail stores to provide information to a centralized system regarding promotions of particular retail goods and services whereby the information is communicated to customers and/or potential customers wishing for promotion information on the particular goods and services.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an exemplary screen shot showing information that may be provided by a business in setting up the business within a software app for providing offers such as discounts on products and/or services in an embodiment of the present invention.

FIG. 2 illustrates an exemplary screenshot showing how a business may search for products that may be tagged by customers in an embodiment of the present invention.

FIG. 3 illustrates an exemplary screenshot showing how a customer may adjust settings or otherwise select a particular product in an embodiment of the present invention.

FIG. 4 illustrates an exemplary screenshot showing that alerts may also be set for offers provided by particular stores in an embodiment of the present invention.

FIG. 5 illustrates an exemplary screenshot of a notification of a discount that may be received by a customer when a product and/or service is offered as a discount by a business in an embodiment of the present invention.

### DETAILED DESCRIPTION OF THE PRESENTLY PREFERRED EMBODIMENTS

The present invention relates to a system and method for tracking product and service discounts. Specifically, the present invention comprises a consumer application resident on a smart phone for tracking discounts of products and services at retailers and a store application for informing consumers of discounts on products and services.

Money Miner is an app that lets a customer pick products or services the customer may want to know about, when they go on sale. For example, suppose a customer wants to know when Pepsi goes on sale. He or she can set an alert for Pepsi by zip code, store specific, and gps range.

Moreover, the customer may set an alert for a plurality of favorite shopping zip codes any time a particular pre-selected product goes on sale in those zip codes the customer will be sent an alert with the details of the sale and what store. For example, if a customer selects “Pepsi” products, and further selects a pre-defined geographic region, any time Pepsi goes on sale in that region, the customer will receive an alert regarding the sale. The customer may also select based on particular stores (such as, for example, based on address), GPS areas (such as within a certain distance of the customer's smart phone based on geolocation information tracked by the customer's smart phone) and/or website URLs.

Products may be pre-selected based on searching or by scanning the bar code, wherein the bar code may be utilized to search a database for information concerning the product desired by the customer.

Business may further utilize an application for supplying information to the system of the present invention concerning promotions, including sales, discounts or other like promotions, concerning one or more products. A business may also gain access to data on who is looking for what to go on sale, and may tailor promotions based on the popularity or desire of customers for promotions on goods and/or services. Moreover, if a retail store business is slow, the business may send out promotions on goods and/or services for limited time periods to attract customers and/or potential customers within a certain time window.

Each store may have its own profile page where it can provide promotion information on specific goods and/or services, but may also include promotion information on specialized services or products that don't contain a bar code There users may also set up alerts for those products or services.

One of the key tools for businesses is the BTW Video. This is an option for businesses to attach a 30 second or less video where they can make up their own ads and the customer can choose to view it or not. If a certain number of viewers view the ad, the business may be charged an amount of money, although any manner of billing businesses may be maintained and the present invention should not be limited as described herein.

In an exemplary embodiment of the present invention, the software application may have a business portal, through which a business that sells products or services may gain access to the business side of the software app, and a customer portal, through which a customer that wishes to purchase products or services may gain access to the customer side of the software app.

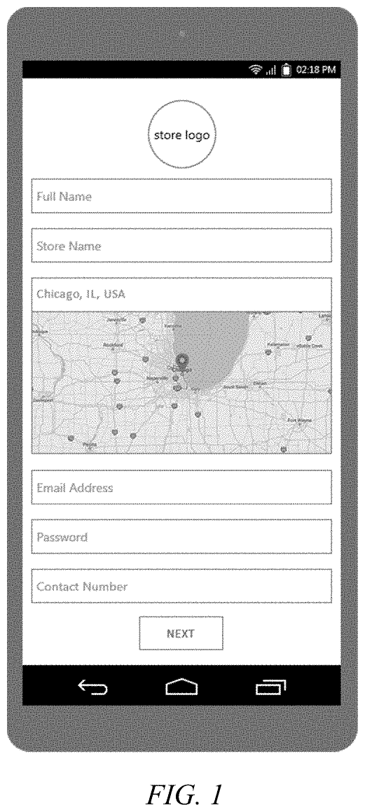

The business portal may allow a business to register, providing information such as the registrant's information, store name, address, location on a virtual map, contact number or other like information. Verification of the business may be accomplished using any available means, such as through authentication via location proximity, mobile number, or other like authentication. The store may also generate a changeable password for secure access to the software app. Additional, the business may add further information, such as a photo of the business or individuals related to the business, “about” information concerning the store and what they sell, and other like information. Of course, businesses may have the ability to edit this information at any time. FIG. 1 illustrates an exemplary screen shot showing information that may be provided by a business in setting up the business within the software app for providing offers such as discounts on products and/or services.

The business may utilize the software app to provide an offer that will be viewable to one or more customers. Specifically, for example, the business may sell several different products that may be tracked via SKU numbers. The business may identify a product for an offer by adding information about the product and running a search for the same, scanning the SKU or other machine-readable information, or provide other searchable information to identify a product for the offer. The business may then provide information concerning a discounted price in the nature of a price decrease, a percentage decrease, or other like means for calculating the offer. The business owner may also provide a duration of the offer in minutes, hours, days or the like.

The business owner may also add other information in the nature of text, audio, video, or other like information concerning the offer and/or the product itself. Preferably, the business owner may add a video to the offer. The video may thus be viewable to customers that view the offer through the customer portal, as detailed below. Preferably, the video or other information is short and easily accessible to a customer, such as, if a video, no longer than about 30 seconds.

In an embodiment of the present invention, the products offered via the software app of the present invention may be tied to the business's inventory, such that the number of products available at a particular retail store may be tracked. The software app may provide the inventory information to a customer.

As noted below, customers may search for particular products, and may “tag” a product so that the software app provides an alert to the customer when a particular desired product or service is discounted through the software app, as detailed above. The business may be able to determine how many people are “watching” for discounts on a particular product or service, or waiting for a product or service to be offered through the software app. Thus, a business may be able to determine whether and when to provide an offer for a particular product or service. For example, if a business receives information from the software app that a relatively high number of customers have tagged or otherwise are watching a particular product, then the business may utilize that information strategically to determine when to place the offer through the software app.

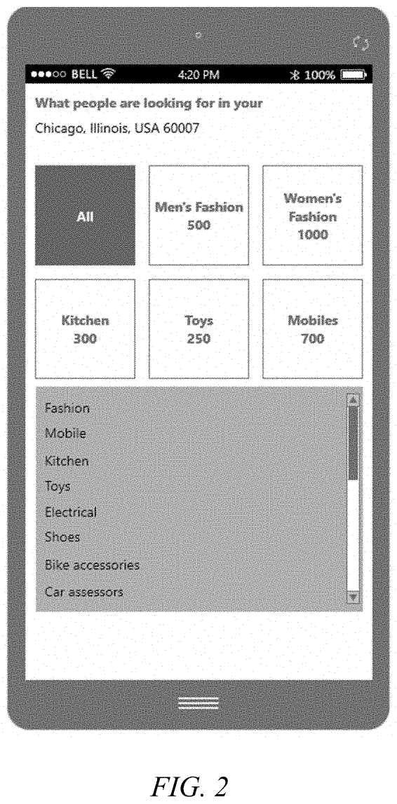

Moreover, the software app may provide location information of customers, based on their settings or via their own GPS coordinates, and the business owner may design offers to strategically take advantage of that location information. For example, customers in a particular zip code may specifically have tagged or otherwise are watching for offers on a particular product. Business owners may receive that information from the software app by running a query, and thus may add an offer for the particular product but only within a store that is located within that particular geographic region, such as zip code. Therefore, the business may more precisely provide offers on products to customers within certain geographic regions based on the information. FIG. 2 illustrates an exemplary screenshot showing how a business may search for products that may be tagged by customers. Specifically, as illustrated in the screenshot of FIG. 2, the business may search for products within the “60007” zip code, and may further search for products tagged by customers by product type. Therefore, a business may be able to find all of the tagged products within a certain geographic area and by product type, and tailor specific offers through the software app to customers in that geographic region based on the information.

The software app, as described above, generally provides details on offers for products within brick-and-mortar stores; however, it should be noted that the software app may also be utilized for tracking offers on products sold online as well. Thus, the software app may facilitate the sale of products through the software app, and offers may be provided for online sale in the same manner as described above.

The software app may further provide easy-to-manage information concerning all offers offered by the business, and easy controls for updating or otherwise editing an offer. Historical information may also be provided to the business concerning past offers, and data relating to purchases driven by the offers may also be tracked.

Further, in an exemplary embodiment of the present invention, a customer may utilize the software app to track offers through a customer portal. Specifically, a customer may sign-up for the service by adding personal information such as user name and password information, and other information that may be useful, such as home address information, preferred geolocation information, such as preferred zip code information, and the like. Other information may also be provided, such as information on product and/or service preferences may be added so that the software app may alert the user to particular offers on products and/or services based on these preferences.

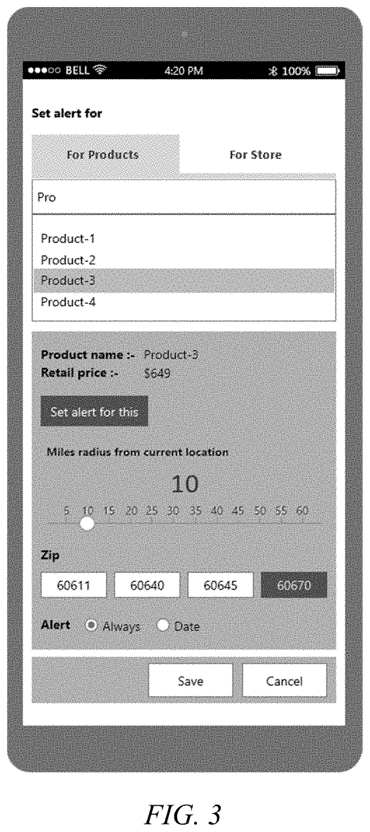

Preferably, once signed-up, the customer may then start to receive information on offers from businesses that may set offers. Specifically, a customer may adjust a setting in the software app to provide only notices concerning offers for products and/or services within a particular geographic area, of a particular product or service type, of a particular product or service specifically, or based on any other information. Preferably, the customer may wish to receive specific information on products that he or she is particularly interested in. Therefore, if the customer is shopping for a computer, for example, the customer may request notices or alerts concerning offers provided by businesses relating to computers that are within a particular geographic region. Specifically, as shown in FIG. 3, the customer may adjust settings or otherwise select a particular product. For example, he or she may search for the product, and then select the product to receive an alert when the product is discounted by a business. The customer may further set the particular geographic region, either by zip code, within a distance of a particular location, within a particular distance of a customer's current location (as determined by geolocation of the user's smart phone or the like) or via any other means. The customer may set the alert on a particular date, always, or in any other timescale.

In an embodiment, customers may tag products for alert notifications by scanning identification code information, such as the SKU, while the customer is physically present within a retail store. Thus, while shopping, the customer may use his or her camera on his or her smart phone to scan the identification information via the software app, and may then select to tag the product to provide the alert notification to the customer when an offer is provided by the particular retail store, or any other retail store, as disclosed herein.

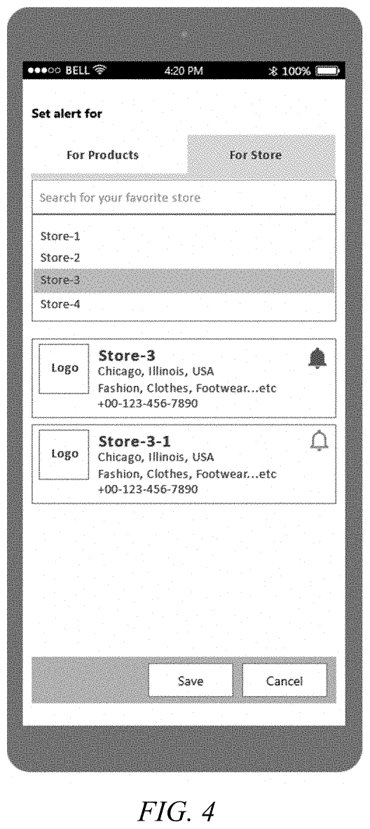

As illustrated in FIG. 4, an exemplary screenshot illustrates that alerts may also be set for offers provided by particular stores. Thus, a store may be searched and set, and alerts may be generated when the particular store provides an offer for any product and/or service, or for particular products and/or services. Therefore, if a customer has a favorite store, he or she may receive alerts on all of the offers provided at any time for that particular store, and therefore may be able to determine the best time to go to the store to take advantage of the offers.

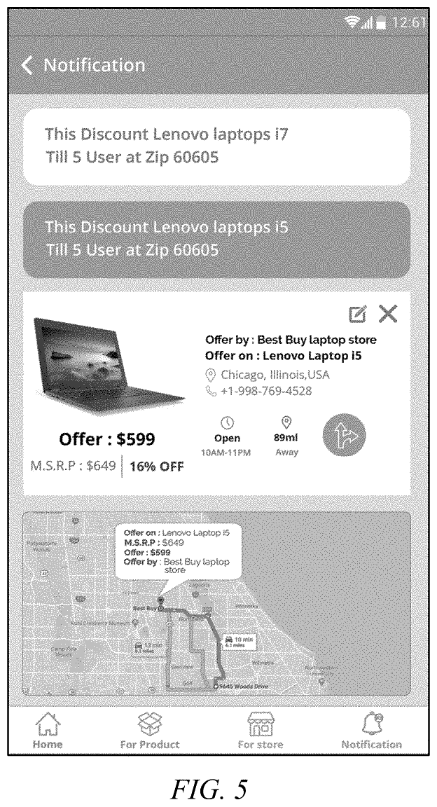

When a product and/or a service is offered as a discount by a business, and if an alert is set for that product and/or service, the customer may receive a notification about the discount, as illustrated in FIG. 5. In this example, a computer is offered at a discount by Best Buy at a particular location in Chicago, Ill. Information concerning the offer is then provided to the customers through the notification, including the price of the computer, the MSRP, the percentage discount, a photo of the product, and other like information concerning the product. Other information, such as information concerning the store itself, such as location information, hours of operation, a map of the store's location and directions from a customer's present position, may also be provided. Thus, the customer can then travel to the store armed with the information provided in the offer to purchase the product and/or the service. In an alternate embodiment, the customer may be provided the opportunity to “tag” the product itself, and purchase the same through the software app, or simply reserve the same so that the customer may be assured that the product is still available after traveling to the store. Alternatively, GPS alerts may be provided to customers when they are close to a retail store that has a product or service of interest to them, or tagged by them. Specifically, a GPS alert may be sent to the customer when the customer, via tracking by his or her smart phone, is within a pre-defined distance of the retail store.

In an embodiment of the present invention, customers may alert other customers to particular offers, discounts or sales when they are alerted to them. Thus, the software app of the present invention may include a social networking aspect, where customers may communicate with other customers. Therefore, if one customer obtain an alert notification concerning an offer on a product or service provided by a business, then customer may send a message, within the software app, to another customer alerting the other customer to the offer provided by the business. Customers may also provide other communications to other customers as desired, and the present invention should not be limited as described herein. For example, a customer may also utilize the in-app messaging service to alert other customers to offers that are not provided by the software app of the present invention. Specifically, a customer may learn of an offer outside the software app, such as through traditional advertising, or a visit to a retail store, and may send an alert through the software app of the present invention to other customers concerning the offer.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A system for tracking product and service discounts comprising:
a customer application resident on a smart phone, wherein the customer application provides alerts to a customer regarding promotions on pre-selected goods or services at a retail store location; and
a retail store application on a computing device configured to allow a retail store to provide information concerning a sales promotion on one or more goods or services to the customer application resident on the smart phone.

2. The system of claim 1 wherein the customer application is configured to receive geolocation information from the customer.

3. The system of claim 2 wherein the geolocation information is entered by the customer.

4. The system of claim 3 wherein the geolocation information is a zip code.

5. The system of claim 2 wherein the geolocation information is tracked by the user's smart phone.

6. The system of claim 1 wherein the customer application is configured to provide an alert to the customer via the customer's smart phone when a retail store provides the sales promotion on a first good or service.

7. The system of claim 6 wherein the alert is configured to be provided to the customer when the retail store is also located within a pre-defined geographic location.

8. The system of claim 6 wherein the alert is configured to be provided to the customer when the customer tags the product within the customer application as being of interest to the customer.

9. The system of claim 1 wherein the retail store application is configured to provide information concerning a first good or service tagged by an interested customer.

10. The system of claim 9 wherein the retail store application is further configured to provide the information concerning the first good or service within a pre-defined geographic location.

11. A method for tracking product and service discounts comprising the steps of:
providing a customer application resident on a smart phone;
providing a retail store application on a computing device;
inputting information into the retail store application concerning a sales promotion on one or more goods or services;
providing an alert regarding the sales promotion on the smart phone of the one or more goods or services.

12. The method of claim 11 wherein the customer application is configured to receive geolocation information from the customer.

13. The method of claim 12 wherein the geolocation information is entered by the customer.

14. The method of claim 13 wherein the geolocation information is a zip code.

15. The method of claim 12 wherein the geolocation information is tracked by the user's smart phone.

16. The method of claim 11 further comprising the step of:
providing an alert to the customer via the customer's smart phone when a retail store provides the sales promotion on a first good or service.

17. The method of claim 16 further comprising the step of:
providing the alert to the customer when the retail store is also located within a pre-defined geographic location.

18. The method of claim 16 further comprising the step of:
providing the alert to the customer when the customer tags the product within the customer application as being of interest to the customer.

19. The method of claim 11 further comprising the step of:
providing information to a retail store concerning a first good or service tagged by an interested customer.

20. The method of claim 19 further comprising the step of:
providing the information to the retail store concerning the first good or service within a pre-defined geographic location.
